(19) United States
(12) Patent Application Publication
(10) Pub. No.: US 2003/0014327 A1
(43) Pub. Date: Jan. 16, 2003

(54) System and method in electronic commerce from hand-held computer units

(76) Inventor: Kristofer Skantze, Lund (SE)

Correspondence Address: BIRCH STEWART KOLASCH & BIRCH, PO BOX 747, FALLS CHURCH, VA, 22040-0747, US

(21) Appl. No.: 10/183,389

(22) Filed: Sep. 24, 2002

Related U.S. Application Data
(60) Provisional application No. 60/303,041, filed on Jul. 6, 2001.

(30) Foreign Application Priority Data
Jun. 29, 2001 (SE) 0102341-5

(51) Int. Cl. G06F 17/60

(52) U.S. Cl. 705/26

(57) ABSTRACT

A system for electronic commerce in a computer network (3) comprises a server unit (CH) which has a first interface with a plurality of first computers (SP), from which users are able to order services using hand-held computer units (1), and a second interface with a plurality of second computers (PP) which handle accounts that are associated with the users of the hand-held computer units. The server unit (CH) has access to a database (20) that for each user stores a user identifier, which indicates the identity of the user, and a computer network address associated with the user identity, the computer network address relating to one of the second computers (PP) that handles an account belonging to the user. The system also comprises a registration unit (RS) which is linked to the database (20) and which allows an association to be made in the database (20) between any computer network address and a given user identifier. Using this arrangement, a service provider that has one of the first computers (SP) is able to accept payment from any payment provider that has one of the second computers (PP), without the service provider needing to have any relationship with the payment provider in advance. A method for enabling financial transactions in such a computer network is also described.

### FIELD OF INVENTION

The present invention relates to a system for electronic commerce in a computer network, and a method for enabling financial transactions in such a computer network.

### BACKGROUND ART

It is known to use a position-coding pattern on a surface for recording in electronic form what is written on the surface using a reading pen that reads off the position-coding pattern continuously during the movement of the pen across the surface. An example of a position-coding pattern that can be used for this purpose is described in Applicant's WO 01/26032, which is hereby incorporated by reference.

The position-coding pattern can code coordinates for a very large number of positions. As a consequence of this, different parts of the position-coding pattern can be dedicated to different functions or different parties. This is described in greater detail in the Applicant's WO 01/48685, which is hereby incorporated by reference.

It is, for example, known that the position-coding pattern and the reading pen can be used to order services. Assume, for example, that a service provider has acquired the right to use a specific part of the position-coding pattern. The service provider advertises the service of supplying particular goods at a particular price. The position-coding pattern is arranged in a part of the advertisement that is intended to be filled in by the person who wants to order the service. When the user fills in his order using his reading pen, the pen reads off the position-coding pattern and decodes this into pairs of coordinates. The sequence of pairs of coordinates describes the movement of the pen across the advertisement when the order is filled in and thus constitutes an electronic version of the order. The electronic order can now be sent via the Internet to the service provider, who can ensure that the order for the goods is fulfilled.

A problem in connection with this is, however, how the service provider is to receive payment from the customer. One possibility is, of course, for the service provider to send an invoice to the person placing the order on the basis of information that the person placing the order has filled in the advertisement. This is, however, in many cases an expensive method in relation to the cost of the service. In addition, there is the risk that the service provider will not be paid by the person placing the order.

Another possibility is for the customer to specify a payment provider in his order, for example a credit card company or account card company, and an account with this payment provider from which the money is to be paid to the service provider. A danger is then that the customer specifies a payment provider that the service provider does not know or with whom the service provider has no contact or agreement, for which reason it will be complicated or perhaps even impossible for the service provider to receive payment for the service. This is an obvious danger when a service provider operates on a global market.

A solution to this could be that the service provider specifies in the advertisement the payment providers from which the service provider can accept payment. However, this restricts the opportunities for the customer to do business in this way, as the customer must then have an account with one of the specified payment providers.

The problems described above also arise in connection with the ordering of services over a computer network using other hand-held computer-based units, such as mobile phones, PDAs (Personal Digital Assistants), barcode readers, and other types of reading pens.

WO 99/08218 discloses a technique for facilitating electronic commerce between customer computers and point of sale computers in a network, without a need to exchange sensitive information such a credit card numbers. Every customer computer is associated with a so-called ISP server (ISP: Internet Service Provider), through which the customer computer enters the network. The customer computers and the point of sale computers are connectable to a transaction server. The transaction server includes a database that associates IP addresses with ISP servers. Here it is presupposed that every ISP server administrates a set of unique IP addresses that are allocated to the customer computers when these are connected to the network through this ISP server. When a user, via a customer computer, initiates a purchase at a point of sale computer, the customer computer is connected to the transaction server. Based on the IP address of the customer computer, the transaction server can identify, via its database, the ISP server of the customer computer and transmit a debit signal to this ISP server which then debits the user.

Evidently, this prior art technique presupposes the existence of a debit relation between a user of a user unit (i.e. a customer computer) and the network provider providing a certain ISP server. Further, it presupposes that the user unit connects to the network through an ISP server that is capable of uniquely identifying the user via the IP address of the user unit in the network.

However, there are situations in which neither presupposition is fulfilled. The above-mentioned reading pen might serve as an example. If the reading pen connects to the network through an external network-connection unit, such as a computer, a mobile phone, a PDA, etc., such that the reading pen communicates in the network using the IP address of the network-connection unit, it might be inappropriate to debit the owner of the network-connection unit for any purchases initiated by the reading pen.

WO 01/01300 discloses a system for electronic commerce via Internet. The system includes a clearing house, in this case a server connected to financial institutions, user units and merchant computers. Seemingly, this clearing house is arranged to receive a credit card number and an encrypted PIN code from a merchant computer, to identify based on the credit card number the financial institution that has issued the credit card number, and to forward the PIN code to this issuer. The issuer then returns an approval signal to the clearing house, which forwards the approval to the merchant computer or the user unit. One drawback of this system is that sensitive information, such as credit card numbers and PIN codes, must be transported in the system. There is thus a risk for unauthorized access to such information.

### SUMMARY OF THE INVENTION

An object of the present invention is therefore to propose a solution that increases the opportunities for service providers to accept payment from different payment providers for services that are ordered from a computer in a computer network using a hand-held computer unit.

This object is achieved completely or partially by means of a system according to claim 1, and a method according to claim 9.

According to a first aspect of the present invention, this relates more specifically to a system for electronic commerce in a computer network, comprising a server unit which has a first interface with a plurality of first computers, from which users are able to order services using hand-held computer units, and a second interface with a plurality of second computers which handle accounts that are associated with the users of the hand-held computer units. The server unit has access to a database that for each user stores a user identifier, which indicates the identity of the user, and a computer network address associated with the user identity, the computer network address relating to one of said plurality of second computers that handles an account belonging to the user. The system further comprises a registration device which is linked to the database and which allows an association to be made in the database between any computer network address and a given user identifier.

In this system, it is possible for any one of the first computers to make contact, by means of a standard procedure, with any one of the second computers regarding payment for the ordered service. There does not need to have been any previous contact between a service provider who has the first computer and a payment provider who has the second computer. In a sense, payments can still be approved by the second computer and transferred from the payment provider to the service provider, by the server unit controlling the routing of funds in the system.

The system can be implemented without any need to transmit sensitive information in connection with financial transactions in the system.

In a system of this type, it is in addition simple to add new service providers and new payment providers to the system.

It should be pointed out that the ordered service can be the provision of goods or the provision of a service.

The database can be a single central database that is located in the server unit, or it can be one or more distributed databases. By means of the database, the server unit has access to an indication of where the user has his account so that the server unit can determine the computer network address of the second computer with which communication is to take place regarding the payment.

The registration device provides flexibility to the system, since it allows a user to set up a personal payment profile in the database by specifying a desired computer network address to a second computer that handles an account of the user. The registration device can be implemented on one or more network-connected servers providing a graphical user interface (GUI) to the user, e.g. via the Internet. It should be noted, however, that Internet is representative of a preferred use of the present invention, but should not be considered limiting, as the invention could apply in other networks and combinations of networks. The graphical user interface can be a web page, which allows a user or a system administrator to enter and submit, after proper authentication, data to be stored in the database.

The system can provide for electronic commerce by the server unit being arranged to determine, in response to the receipt of a first message from one of the first computers and based on the database, a computer network address of one of said plurality of second computers that handles an account belonging to the user. Such a first message can contain the user identifier that indicates the identity of a user who has ordered a service from the first computer from which the first message was received and an amount that the user is to pay for the service.

The user identifier can be a computer unit identifier that identifies the user's hand-held computer unit. Such an identifier can, for example, consist of a sequence of alphanumeric symbols, which is hard-coded or stored in some other manner in the hand-held computer unit in such a way that it is difficult to change. The computer unit identifier can be sent automatically from the hand-held computer unit together with the order for the service and can be used by the server unit to determine, by database look-up, the computer network address of the second computer that handles an account belonging to the user of the hand-held computer unit in question. The use of this type of computer unit identifier allows compact storage and transmission of user information.

If several users use one and the same hand-held computer unit to place orders, the user can authenticate himself to the hand-held computer unit, whereupon this adds a suffix to the computer unit identifier that defines the user unambiguously so that the computer unit identifier with the suffix can be used by the server unit for the database look-up. Alternatively, the user can authenticate himself to some other unit, such as the server unit.

Alternatively, the user identifier is a digital certificate.

At least one user identifier can be associated in the database with two or more different computer network addresses that refer to two or more different second computers that each handle respective accounts belonging to the user. The server unit can have access to conditions for the selection of the respective computer network address. The conditions can, for example, consist of a first account being selected for amounts below a specified amount and a second account being selected for amounts above this limit. This makes it possible for a user to have several accounts associated with his hand-held unit and to control how these are to be used. The fact that the control is carried out in the server unit results in simplifications regarding the processing in the first and second computers, which reduces the requirement for what these must be able to process in order to be able to be connected to the system.

The conditions can be entered into the system by the user, or a system administrator, through the registration device, or through any other electronic interface to the database or the server unit.

According to a second aspect of the present invention, it relates to a method for enabling financial transactions in a computer network, the method comprising: establishing registration agreements between a transaction enabler and users of hand-held computer units in the network; establishing first transaction agreements between the transaction enabler and service providers in the network; and establishing second transaction agreements between the transaction enabler and payment providers in the network; wherein the users, when ordering services with the service providers, are enabled to select a transaction enabler payment method, in which the transaction enabler controls routing of debit signals and funds between the service providers and the payment providers, based on the registration agreements and the first and second transaction agreements.

With this method, service providers can accept payment from different payment providers, without the need for explicit agreements between the service providers and the payment providers. By the users of the hand-held computer units being registered with the transaction enabler, via the registration agreements, the transaction enabler is capable of transmitting a request for funds from a service provider to an appropriate payment provider for debiting the user that initiated the request at the service provider by placing an order for a service. The first and second transaction agreements further allows the transaction enabler to control the routing of funds back from the payment provider to the service provider.

Other objects, advantages and characteristics of the invention are apparent from the following detailed description of the invention, from the appended claims and from the drawings.

### BRIEF DESCRIPTION OF THE DRAWINGS

The present invention will now be described by an exemplary embodiment and with reference to the accompanying drawings in which

FIG. 1 shows schematically a system for electronic commerce according to an embodiment of the present invention,

FIG. 2 shows schematically a database to which a server unit in the system has access,

FIG. 3 shows a flow chart of an example of the operation of the server unit, and

FIG. 4 indicates the underlying agreements between the legal entities that interact in the system of FIG. 1.

### DETAILED DESCRIPTION OF EMBODIMENTS OF THE INVENTION

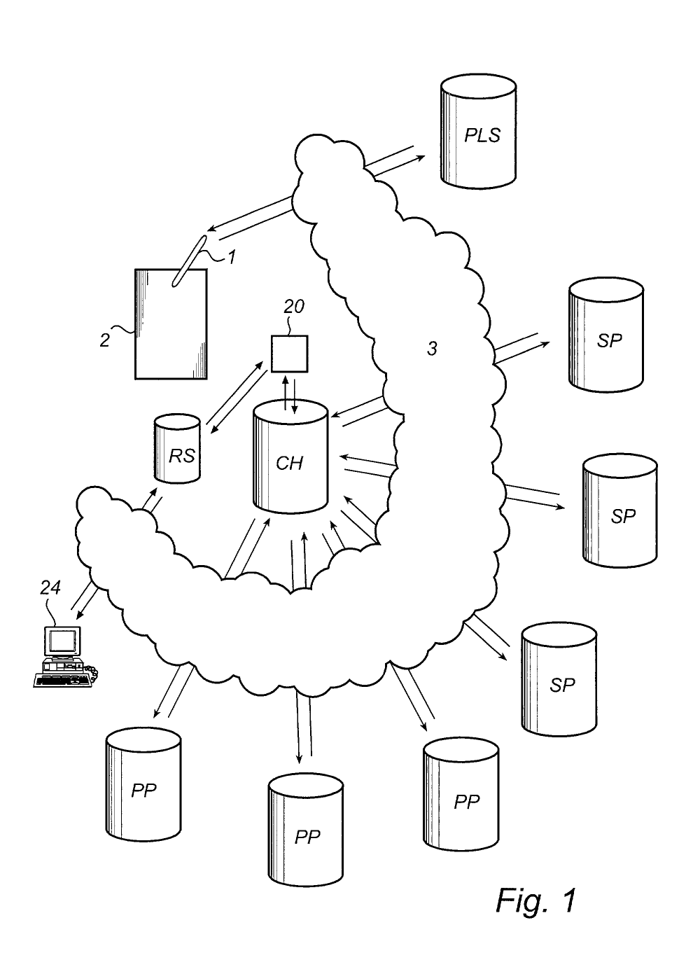

In the following, an example is given of a system that makes possible mobile commerce over a computer network, such as the Internet, where a service provider can accept payment from any payment provider. In this example, users use reading pens and products with position-coding patterns that are read off by the pens for ordering services from the service providers. FIG. 1 shows for the sake of simplicity only one reading pen 1 and one product 2 (the position-coding pattern is not shown). The reading pen can be of the type that is described in WO 01/26032. The product 2 can be any type of product that can be provided with a position-coding pattern, but can usually be a newspaper, an advertising flyer, a brochure or the like.

The system comprises a plurality of computers that are interconnected via a computer network 3, for example the Internet.

A first plurality SP of these computers belong to service providers that provide the products 2 with position-coding patterns by means of which the users can order services from the service providers.

A second plurality PP of the computers belong to various types of payment providers, who at the request of the users can provide payment for services that have been ordered from the service providers.

By a payment provider is meant in this context a party with which a user has a relationship that makes it possible for the user to pay for orders for services that are placed by means of a hand-held computer unit, such as the reading pen 1, to a computer in a computer network, by the user referring directly or indirectly to the payment provider, who thereafter pays the service provider. The payment provider is in turn paid by the user in advance or subsequently or directly when the order is placed.

The payment provider can, for example, be a bank, a credit card or account card or payment card company, or some other company with which the user has an account. The payment provider can also be a mobile telephone operator or some other operator with which the user has an account or a subscription.

There can be additional types of payment providers. A user can, for example, buy vouchers from a payment provider for use later for making payments over the Internet. In this case, the payment provider redeems the prepaid vouchers.

In all cases, it can be regarded as if the user has an account with the payment provider, which means that the payment provider can make payments to a service provider at the request of the user. In this application, when it is stated that the user has an account with a payment provider, the account is always to be interpreted in the widest possible sense and comprises at least all the above-described cases.

If each of the service providers is to be able to accept payments from each of the payment providers, each service provider must know each payment provider and have set up or be in the process of setting up a relationship with each of these. If there are many payment providers, this becomes difficult. In addition, difficulties arise when new payment providers enter the system.

Therefore the system also comprises a so-called clearing house which is realized using a server unit CH that has a first interface with each of the computers SP of the service providers and a second interface with each of the computers PP of the payment providers. The server unit CH thus constitutes a node in the computer network 3 via which communication takes place between the computers SP of the service providers and the computers PP of the payment providers. The server unit CH is constructed as a traditional server unit with one or more processors, working memory, program memory and various peripheral units.

The server unit CH has access to a database 20 in which are stored, in this example, unique identities, called pen ID, for all the pens 1 that can be used for payment in the system. For each pen ID there is additionally stored at least one indication of a payment provider in the form of a computer network address of the computer PP of the payment provider.

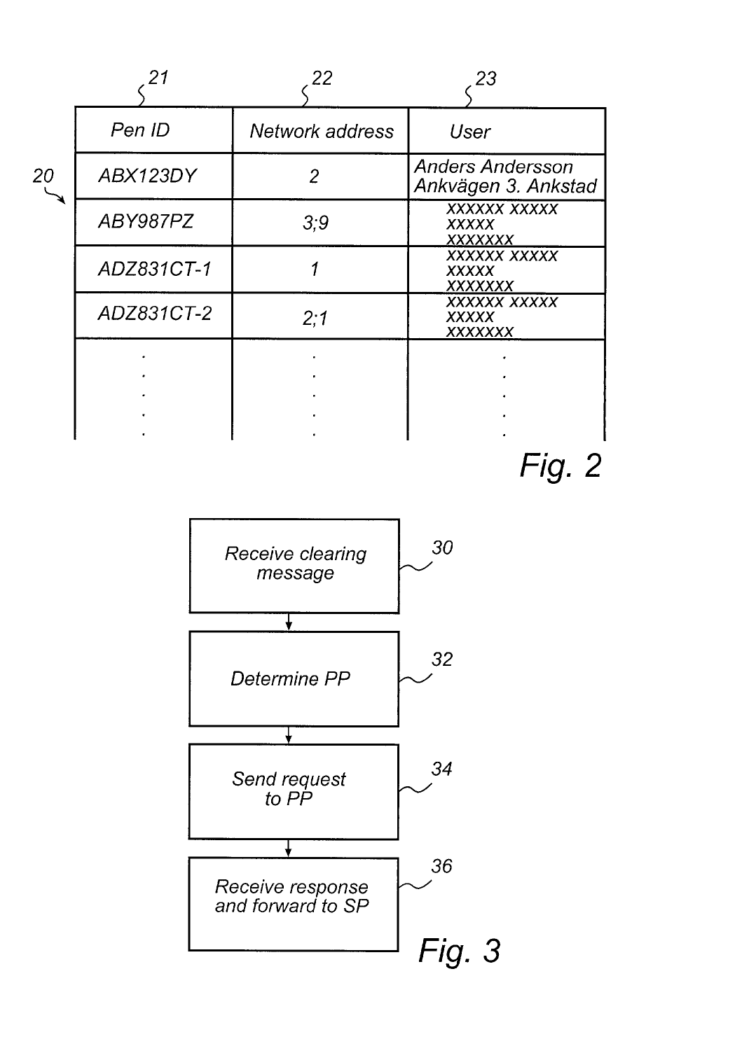

The database is further illustrated in FIG. 2 by means of a table 20 that contains a first column 21 with pen IDs in the form of sequences of alphanumeric symbols and a second column 22 with computer network addresses of payment providers. The computer network address is not stored here in explicit form, but as a number that can be converted into the actual computer network address via another table (not shown).

In this example, the database 20 contains additional information associated with the pen ID, that is the name and postal address of the owner or user of the pen. This is shown schematically in a third column 23 in the table in FIG. 2.

Certain users can want to have the ability to use their pen to pay for different ordered services via different payment providers. For example, the user may want to pay small amounts via his telephone bill and larger amounts via his bank account. The user can then have more than one account associated with his pen. This is illustrated in FIG. 2 by more than one computer network address of a payment provider in column two in the table being stored in the database 20.

If the user has more than one account associated with his pen, the server unit CH can also store rules or conditions that control from which of the accounts a payment is to be made. The rules can, for example, be based on the size of the payment. They can be individual, that is apply to a specific user, or general, that is apply to a larger group of users or for all users.

The system of FIG. 1 also includes a registration server RS which can, but need not be, separate from the server unit CH. The registration server RS provides a means for authorized parties to add and change data in the database 20. Typically, the registration server RS includes a communication module connected to the network 3 and arranged for communication with a user terminal 24, an authentication module for authentication of the user, and a database module for communication with the database. The skilled person will realize that such a registration server may be implemented in a multitude of different ways, using prior art technology. For example, the communication module may utilize suitable standardized Internet protocols, optionally with a security layer providing confidentiality, integrity and non-repudiation.

The registration server RS may provide a web page registration form for access from any suitable user terminal 24 with a web browser, such as a PC, a mobile phone, a PDA, etc. The user may enter data via the web page, either for first-time registration with the system or for subsequent updating of data stored in the database 20. Alternatively or additionally, the registration server RS may provide a registration form for downloading via the user terminal 24. The downloaded form may be printed, filled in by the user and transmitted to an authorized system administrator that enters the user data in the database 20 via the registration server RS. Alternatively or additionally, registration forms with position-coding pattern may be provided in the system. The user may simply enter relevant data on the form with the reading pen 1, whereupon the data thus registered is routed from the pen 1 to the registration server RS for storage in the database 20. In such an embodiment, the pen ID may be automatically transmitted with the data from the pen 1 to the registration server RS.

The transmission of data from the pen to different parties in the system will now be further described with reference to FIG. 1. The system includes an address server unit PLS that has access to a database with information about, among other things, computer network addresses of the different parties that have the right to use different parts of the position-coding pattern. If a reading pen 1 in the system sends one or more pairs of coordinates that were decoded from a part of the position-coding pattern to the address server PLS, this can thus determine which party has the right to use this part of the position-coding pattern. It can thereafter return the corresponding computer network address so that the reading pen 1 that sent the pair of coordinates can send information that was written on the corresponding part of the position-coding pattern to the party that has the right to use this part. In this way, the pen 1 does not itself need to know where it is to send information that has been written on different parts of the position-coding pattern.

The system exemplified in FIG. 1 works as follows. Assume that a user sees an advertisement on a product 2 from a service provider and wants to order a service in accordance with an offer in the advertisement. The user then fills in the information requested in the advertisement using his reading pen 1. In this case, the information is the name and address of the person to whom the service is to be provided. The area in the advertisement in which the information is filled in is provided with a position-coding pattern that is read off by the pen 1 while the pen is moving when the information is being filled in. The pen 1 decodes the position-coding pattern and generates a sequence of pairs of coordinates that describes how the pen was moved when filling in the advertisement. The sequence of pairs of coordinates thus constitutes an electronic version of the information that was written on the advertisement.

When the owner of the pen 1 has instructed the pen to send the order for the service, for example by the owner of the pen making a mark with the pen in a special “send” box in the advertisement, the pen sends its unique pen identity (pen ID), and at least one pair of coordinates to a predetermined address in the computer network. The address server PLS is available at this address.

The service provider with whom the owner of the pen places his order has acquired the right to use a specific part of the pattern, namely the part that is to be found in the advertisement. When the address server PLS receives the pair of coordinates from the pen 1, it identifies to which part of the position-coding pattern the pair of coordinates belongs and what computer network address is associated with this part of the position-coding pattern. The identified address is sent back to the pen 1, the address server PLS utilizing the pen ID to determine where the address is to be sent. When the pen 1 receives the address of the service provider, it sends all the information that the owner of the pen wrote in the advertisement to the service provider's computer SP, in the form of the recorded pairs of coordinates. The pen ID is also sent.

The method for electronic recording of information that is written on the position-coding pattern, for looking up addresses in the address server and for sending the information to the address obtained from the address server is described in greater detail in Applicant's WO 01/48678 and WO 01/48591, which are hereby incorporated by reference.

When the computer SP of the service provider receives the message from the pen 1, the message can be printed or displayed on a screen in graphical form, that is as it was written in the advertisement, so that the message can be interpreted by the service provider's personnel. Alternatively, the processing of the message can be completely computerized. The text can, for example, be input into a character interpretation software, such as ICR (Intelligent Character Recognition) or OCR (Optical Character Recognition) software, so that the contents in the message can be interpreted and processed by the computer.

The amount that the user is to pay for the ordered service is at all events to be determined in the computer SP of the service provider in some suitable way. In addition, a clearing message is generated that contains at least the pen ID, the amount and the identity of the service provider. This clearing message is sent from the computer SP of the service provider via the computer network 3 to the server unit CH of the clearing house, the computer network address of which has previously been stored in the computer SP of the service provider.

When the server unit CH of the clearing house has received the clearing message, it uses the pen ID in order to check in the database 20 which payment provider is to pay for the ordered service. If there is only one payment provider, the server unit CH selects this payment provider. If there is more than one payment provider, a selection needs to be made. The selection can be based on previously determined rules, such as that if the amount is within a first range the first payment provider is selected and if the amount is in a second range the second payment provider is selected.

The selection can alternatively be based on information that is sent in the clearing message, as described below.

The server unit CH thereafter generates a payment request to the payment provider thus selected. The payment request contains the amount that the clearing house received in the clearing message and information that makes it possible for the payment provider to determine from which account the payment is to be made. In this example, this information consists of the user's name and address, obtained from the database 20 by the server unit CH.

When the payment request is received by the payment provider, the payment provider checks whether the payment can be carried out. This check can, for example, consist of checking whether the amount in question is available in the user's account, whereupon the amount is reserved. Thereafter the payment provider sends a payment response back to the server unit CH, which in turn forwards the payment response to the computer SP of the service provider. If the result of the check is positive, the service provider can now fulfill the order. optionally, the fulfillment of the order can be preceded by the computer SP of the service provider requesting a final confirmation of the order from the user. For example, the order, the amount and the account from which the amount is to be taken can be shown on a display on the user's pen or on some other unit which is accessible to the user and allows computer network communication. The confirmation can alternatively be requested at an earlier stage, for example before the server unit CH of the clearing house sends the payment request.

The payment is finally sent from the payment provider, via the clearing house, to the account of the service provider that is recorded in the server unit CH.

The method described above, which is carried out in the server unit CH of the clearing house, is fully computerized. FIG. 3 summarizes the method in a schematic flow chart.

In step 30, the server unit CH of the clearing house receives a clearing message from the computer SP of a service provider. In step 32, the server unit CH determines which payment provider is to make the payment. In step 34, the server unit CH sends a payment request to the computer PP of the payment provider. Finally, in step 36, the server unit CH receives the response to the payment request and forwards this to the computer SP of the service provider concerned.

By means of the registration server RS, an owner or user of a pen can link to the pen one or more accounts from which he or she wants to be able to make payments, for example by filling in a form at a computer network address. When the form has been filled in, at least some of the information is stored in the database 20. Information in the form may also be sent to the payment provider/providers, e.g. to inform the payment provider/providers that the user has consented to be debited by the payment provider/providers for transactions initiated with a reading pen. In this example, the information for storage in the database 20 comprises at least one payment provider, the pen ID and the name and address of the user. If there is more than one payment provider, the information can also comprise rules for the selection of payment provider.

A service provider can register with the clearing house by a registration procedure, in which among other things the service provider provides information about his computer network address and about the account to which payments are to be made. In addition, the computer SP of the service provider needs to be able to communicate with the server unit CH of the clearing house according to a standard procedure, according to which the service provider in this example sends a clearing message with information about the pen ID, the amount for the ordered service and information that identifies the service provider, to the computer network address of the server unit CH.

A payment provider can also register with the clearing house by a registration procedure, in which among other things information about the computer network address of the payment provider and the account to which payments are to be made, is recorded with the clearing house. The payment provider also needs to be able to communicate with the server unit CH of the clearing house according to a standard procedure, according to which the payment provider in this example receives a payment request that comprises an amount and the name and address of the user who wants to have a payment made and returns, to the computer network address of the server unit CH, a result in the form of an approval or rejection of the payment.

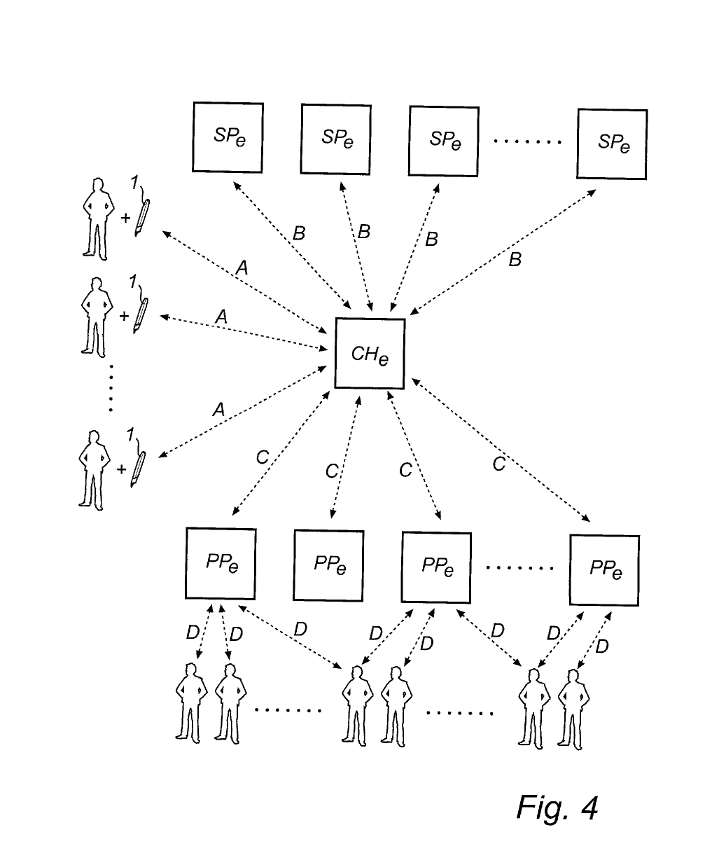

FIG. 4 schematically summarizes the agreements or contracts set up between the different parties or legal entities in the above system. In FIG. 4, the service providers, the clearing house and the payment providers are denoted by SPₑ, CHₑ and PPₑ, respectively. The clearing house CHₑ establishes registration agreements A with the users or owners of the reading pens 1 in the network 3. The clearing house CHₑ also establishes transaction agreements B with service providers SPₑ in the network 3. Further, the clearing house establishes transaction agreements C with payment providers PPₑ in the network 3, which in turn have transaction agreements D with the users or owners of the reading pens 1.

Registration agreement A may be set up when the user registers with the system to submit a user profile for storage in the database of the clearing house CHₑ. The user may affirm that the submitted user profile is correct, and the clearing house CHₑ may take responsibility for routing payments on behalf of the user. The user may also agree to handle the reading pen as a payment instrument, so that the clearing house CHₑ is relieved from any liability if, for example, the reading pen is stolen.

Transaction agreement B may be set up when the service provider SPₑ registers with the clearing house CHₑ. The subscription provider SPₑ and the clearing house CHₑ may agree on a communication standard including security protocols. The clearing house CHₑ may agree to transfer funds to an account of the service provider SPₑ in response to the clearing message being verifiable with respect to the user profile stored in the database, and optionally in response to the payment request being verifiable at the relevant payment provider PPₑ. Alternatively, the clearing house CHₑ may agree to include a service provider account in the payment request to the payment provider PPₑ, and the service provider SPₑ may agree to receive funds directly on this account from any payment provider PPₑ in the system.

Transaction agreement C may be set up when the payment provider PPₑ registers with the clearing house CHₑ. The payment provider PPₑ and the clearing house CHₑ may agree on a communication standard including security protocols. The payment provider PPₑ may accept to receive the payment request and acknowledge to transfer funds to an account of the clearing house CHₑ, or directly to an account of the service provider SPₑ as specified in the payment request, in response to the payment request being verifiable by the payment provider PPₑ.

Transaction agreement D may relate to an existing debit relation between the user and the payment provider PPₑ. Such a debit relation may include an account in a bank or at a credit card company, an account or subscription with a network operator, or purchase of vouchers issued to be used for payment in the system. The debit relation may be based on the user paying in advance, directly when the order is submitted or after receipt of an invoice or the like. A transaction agreement D may be set up, or updated, in connection with the user signing the registration agreement A, by the user agreeing to be debited by the payment provider PPₑ.

The legal agreements A-D allow a registered user, when ordering a service with a service provider SPₑ, to select to pay for the service ordered via the clearing house CHₑ, which controls the routing of debit signals and corresponding funds between the relevant parties in the system.

More specifically, the clearing house CHₑ may receive the clearing message from the service provider SPₑ, based on the transaction agreement B. The clearing house CHₑ may then send a payment request to the payment provider PPₑ, based on the registration agreement A and the transaction agreement C. The transfer of funds from the payment provider PPₑ to the service provider SPₑ are controlled by the clearing house CHₑ, based on the transaction agreements B and C.

In one embodiment, the service provider SPₑ may obtain funds from the clearing house CHₑ, which in turn may obtain corresponding funds from the payment provider PPₑ, who may debit the user based on the transaction agreement D.

Alternatively, the service provider SPₑ may obtain funds directly from the payment provider PPₑ, for example by the latter transferring the funds to a service provider account specified in the payment request from the clearing house CHₑ.

The clearing house CHₑ may operate according to a business model based on any of the following sources of revenue, or combinations thereof. The clearing house CHₑ may collect a subscription fee from the users or owners of the reading pens and/or the service providers SPₑ and/or the payment providers PPₑ, for the routing of debit signals and funds in the system. The clearing house CHₑ may collect a transaction fee for every use of the clearing house for payment for a service. The transaction fee can be a flat-rate fee, or a percentage of the funds transferred to the service providers. For example, the clearing house CHₑ may add a transaction fee to the amount specified in the payment request to the payment provider PPₑ, who may choose to debit all or part of this transaction fee to the user's account. In a further alternative, the clearing house CHₑ deducts the transaction fee from the funds transferred to the service provider SPₑ. The conditions for any such fees are suitably set down in the proper agreements A-D.

The invention has been described above in the form of a few exemplifying embodiments. However, the invention is in no way limited to these, but covers many other variants, according to what is defined by the scope of protection of the appended claims and, in addition, can easily be recognized by a person skilled in the art.

For example, the clearing house does not need to have a direct interface with each of the account-keeping parties that are permitted in the system. Instead, it can have an interface with one or more subsidiary clearing houses, which in turn have interfaces with one or more payment providers.

The clearing house's database does not need to be located at the same node in the computer network as the clearing house itself. It must, however, be accessible to the clearing house in some way.

The clearing house's database does not need to be central. It can be distributed in one or more hardware units in the network. Part of the database may even be distributed in all the pens in the system. More specifically, information about the payment provider could be stored in the pen and sent in the order to the service provider and forwarded to the clearing house. For the sake of simplicity and security, the payment provider can be stored in the pen in the form of a code, for example a number, each payment provider with whom the clearing house has contact having its own code, and the clearing house determining, upon the receipt of the clearing message, which payment provider is to make the payment, based on the code. In such an embodiment, the registration server may communicate with the address server (PLS in FIG. 1), which is accessible to all pens in the system, to submit information about the selected payment providers for storage in a memory unit in the respective pen.

If the user has accounts with several payment providers, the user can make a selection when the order is placed, irrespective of whether the database is partly distributed in the pens or not. The selection can, for example, be made by the user writing the selection with the pen on the position-coded product in a predetermined way, and the selection being sent in the information to the service provider and forwarded to the clearing house. Alternatively, the selection can, for example, be made using a mobile telephone or some other unit that is used as a modem for the communication with the service provider. The selection can also be made in response to a direct request from the clearing house, the request being sent, on the basis of the pen identity, from the clearing house to the pen or some other unit connected to this, by means of which the user can be made aware of the request.

In the example above, an electronic reading pen is used to record the information that is sent to the sales computer. The information can, however, just as well be recorded using some other hand-held computer unit, such as a mobile phone, a PDA or a bar-code reader. In the two first cases, the user can learn about the opportunity to order services, for example, through electronic messages that are sent to the unit and shown on its display. In all cases, a unique identity, corresponding to the pen ID described above, may be used to identify the hand-held unit.

In the example above, the pen ID is used to identify the user in the clearing house and to determine from which payment provider the payment is to be made. If several different users use the same pen, the pen ID can be provided with a suffix in order to identify which user is using the pen at present. This is illustrated in the table in FIG. 2 by the pen ID in rows 3 and 4 having the same introduction but a suffix of -1 and -2 to indicate user 1 and 2 respectively.

The pen ID does not necessarily need to be sent to the service provider and the clearing house. The user can instead be identified by, for example, a digital certificate that contains user information, such as name and address and/or social security number, and that is sent to the clearing house. For example, digital certificates under the ITU-T Recommendation X.509 may be used. Upon receipt of such a certificate, the clearing house may forward it to a trusted Authority that, after checking appropriate revocation lists, returns a verification signal indicating the authenticity of the digital certificate. The clearing house's database must then be constructed in a corresponding way, so that the user information in the certificate can be used to determine the payment provider. Other ways of identifying the user are also possible.

In addition, the database can contain explicit account information, such as account number, as a supplement to the information about the payment provider. Optionally, the account number can even replace the information about the payment provider, provided the payment provider can be identified from the account number. If the user has several accounts with the same payment provider, the database can contain information about this and, optionally, rules for the selection of account. Information about the selected account is then sent in the payment request to the payment provider.

As mentioned, the user does not need to have an account in the traditional narrow sense with the payment provider. The user can, for example, purchase vouchers that are used for the payment and are redeemed by the payment provider. In this case, the database can contain information that makes it possible to determine the computer network address of the payment provider who is to redeem the vouchers.

1. A system for electronic commerce in a computer network (3), comprising a server unit (CH) which has a first interface with a plurality of first computers (SP), from which users are able to order services using hand-held computer units (1), and a second interface with a plurality of second computers (PP) which handle accounts that are associated with the users of the hand-held computer units, wherein the server unit (CH) has access to a database (20) that for each user stores a user identifier, which indicates the identity of the user, and a computer network address associated with the user identity, the computer network address relating to one of said plurality of second computers (PP) that handles an account belonging to the user, said system further comprising a registration device (RS) which is linked to the database (20) and which allows an association to be made in the database (20) between any computer network address and a given user identifier.

2. A system according to claim 1, in which the user identifier is a computer unit identifier that uniquely identifies the user's hand-held computer unit (1).

3. A system according to claim 1, in which the user identifier is a digital certificate.

4. A system according to claim 1, in which at least one user identifier is associated in the database (20) with two different computer network addresses that relate to two different second computers (PP) that each handle an account belonging to the user and in which the server unit (CH) has access to conditions for the selection of the respective computer network address.

5. A system according to claim 4, in which the registration device (RS) allows inputting of said conditions into said system.

6. A system according to claim 1, in which the server unit (CH), in response to the receipt of a first message from one of the first computers (SP) and based on the database (20), is arranged to determine a computer network address of one of said plurality of second computers (PP) that handles an account belonging to the user, wherein the first message contains the user identifier that indicates the identity of a user who has ordered a service from the first computer from which the first message was received and an amount that the user is to pay for the service.

7. A system according to claim 6, in which the server unit (CH) is further arranged to send to the determined computer network address a request for approval of payment for the service ordered by the user, which request comprises the identity of the user who placed the order and the amount of the order, and to receive a result of the request for approval and to forward this to the first computer from which the first message was received.

8. A system according to claim 6, in which the server unit (CH) is arranged to send, when the computer network address has been determined, an approval to the first computer from which the message was received, and then to send to the determined computer network address a request for approval of payment for the service ordered by the user, which request comprises the identity of the user who placed the order and the amount of the order.

9. A method for enabling financial transactions in a computer network, comprising: establishing registration agreements (A) between a transaction enabler (CHₑ) and users of hand-held computer units (1) in the network; establishing first transaction agreements (B) between the transaction enabler (CHₑ) and service providers (SPₑ) in the network; and establishing second transaction agreements (C) between the transaction enabler (CHₑ) and payment providers (PPₑ) in the network; wherein the users, when ordering services with the service providers (SPₑ), are enabled to select a transaction enabler payment method, in which the transaction enabler (CHₑ) controls the routing of debit signals and funds between the service providers (SPₑ) and the payment providers (PPₑ), based on the registration agreements (A) and the first and second transaction agreements (B, C).

10. A method according to claim 9, wherein the transaction enabler payment method includes: the transaction enabler (CHₑ) receiving a first debit signal from a service provider (SPₑ), based on the first transaction agreement (B); the transaction enabler (CHₑ) sending a second debit signal to a payment provider (PPₑ), based on the registration agreement (A) and the second transaction agreement (C); and the transaction enabler (CHₑ) controlling the transfer of funds from the payment provider (PPₑ) to service provider (SPₑ), based on the first and second transaction agreements (B, C).

11. A method according to claim 10, wherein the registration agreement (A) includes the user acknowledging an association, as registered with the transaction enabler (CHₑ), between the user and one of the payment providers (PPₑ); and wherein the first transaction agreement (B) includes the transaction enabler (CHₑ) acknowledging to transfer funds to each service provider (SPₑ) in response to the first debit signal being verifiable with respect to the association.

12. A method according to claim 10, wherein the registration agreement (A) includes the user acknowledging an association, as registered with the transaction enabler (CHₑ), between the user and one of the payment providers (PPₑ); and wherein the first transaction agreement (B) includes the transaction enabler (CHₑ) acknowledging to transfer funds to each service provider (SPₑ) in response to the first debit signal being verifiable with respect to the association and the second debit signal being verifiable at the payment provider given by the association.

13. A method according to claim 9, wherein the registration agreement (A) includes the user acknowledging an association, as registered with the transaction enabler (CHₑ), between the user and one of the payment providers (PPₑ).

14. A method according to claim 10, wherein the second transaction agreement (C) includes the payment provider (PPₑ) accepting to receive the second debit signal and acknowledging to transfer funds in response to the second debit signal being verifiable by the payment provider (PPₑ).

15. A method according to claim 14, wherein the second transaction agreement (C) includes the payment provider (PPₑ) acknowledging to transfer the funds to the transaction enabler (CHₑ).

16. A method according to claim 14, wherein the second transaction agreement (C) includes the payment provider (PPₑ) acknowledging to transfer funds to an account specified in the second debit signal.

17. A method according to claim 9, wherein the transaction enabler payment method includes: the service providers (SPₑ) obtaining funds from the transaction enabler (CHₑ) based on the first transaction agreements (B) and the registration agreements (A), the transaction enabler (CHₑ) obtaining corresponding funds from the payment providers (PPₑ) based on the second transaction agreements (C), and the payment providers (PPₑ) debiting the users.

18. A method according to claim 9, wherein the registration agreement (A) includes the user acknowledging to handle the computer unit (1) as a payment instrument.

19. A method according to claim 9, wherein the transaction enabler (CHₑ) collects a subscription fee from the users and/or the service providers (SPₑ) and/or the payment providers (PPₑ).

20. A method according to claim 9, wherein the transaction enabler (CHₑ) collects a transaction fee for every use of the transaction enabler payment method.

21. A method according to claim 9, wherein the transaction fee is calculated as a percentage of the funds transferred to the service providers (SPₑ).

22. A method according to claim 10, wherein the registration agreement (A) includes the user acknowledging an association, as registered with the transaction enabler (CHₑ), between the user and one of the payment providers (PPₑ).
